(19) United States
(12) Patent Application Publication
(10) Pub. No.: US 2018/0297625 A1
(43) Pub. Date: Oct. 18, 2018

(54) A Lever For A Steering Column Assembly

(71) Applicant: TRW Limited, Solihull, West Midlands (GB)

(72) Inventors: Harry Kingston-Jones, Steyning, Sussex (GB); Niclas Davies, Birmingham, West Midlands (GB); Colin Handy, Coventry, West Midlands (GB); Piotr Wegrzyn, Bielsko-Biala (PL)

(73) Assignee: TRW Limited, Solihull, West Midlands (GB)

(21) Appl. No.: 15/766,496

(22) PCT Filed: Oct. 7, 2016
(86) PCT No.: PCT/GB2016/053130

§ 371 Date: Apr. 6, 2018

(30) Foreign Application Priority Data
Oct. 8, 2015 (GB) 1517828.8

(51) Int. Cl. B62D 1/184; G05G 1/04

(52) U.S. Cl. CPC B62D 1/184; G05G 1/04

(57) ABSTRACT

A locking lever for a clamp mechanism of a steering column assembly comprises a first portion, a second portion that extends from the first portion, and a connecting portion or region located between the first portion to the second portion about which the second portion will preferentially breakaway from the first portion in the event of an impact by an occupant of the vehicle on the second part, the lever further comprising a flexible tether that prevents the second portion fully separating from the first portion after the lever has broken about the connection portion or region.

### CROSS-REFERENCE TO RELATED APPLICATIONS

This application is a national stage of International Application No. PCT/GB2016/053130, filed 7 Oct. 2016, the disclosures of which are incorporated herein by reference in entirety, and which claimed priority to Great Britain Patent Application No. 1517828.8, filed 8 Oct. 2015, the disclosures of which are incorporated herein by reference in entirety.

### BACKGROUND OF THE INVENTION

This invention relates to improvements in levers for steering column assemblies, and to an adjustable steering column assembly including a locking lever.

It is known to provide a steering column assembly that can be adjusted for at least one of reach and rake. The steering column assembly typically comprises a shroud that supports a steering shaft. Where the assembly is adjustable for reach the shroud may comprise an upper part and a lower part, with the two being telescopically adjustable to allow the length of the shroud to be altered. The steering shaft, which may also be telescopically, extends along the shroud and is supported by one or more bearing assemblies. One end of the steering shaft connects to a steering wheel of the vehicle and the other to a steering rack or gearbox. The shroud is held in position by a clamp mechanism that secures the shroud to a support bracket which is in turn secured to a fixed part of the vehicle such as a cross-member located behind the dashboard.

The steering column assemblies are often manually adjustable and to achieve this the clamp mechanism may be connected to an operating lever that can be operated by a user to move the clamp mechanism between an unclamped condition in which at least a part of the shroud can be moved relative support bracket and a clamped condition in which the part of the shroud is fixed relative to the support bracket. The clamp mechanism typically includes a clamp pin or bolt that rotates around its axis during clamping and unclamping and the lever allows the driver to apply a sufficient turning moment the clamp pin or bolt.

The lever is usually a sturdy affair, with a root part that is rotatable about an axis and an end part extending away from the root and forming a handle that the user can grip. The longer the lever, the higher the torque that the user can apply for a given strength of user. The lever should be relatively rigid to give a high quality feel to the user, and also to ensure it is robust enough to withstand repeated use during the life of the vehicle that it is fitted to.

A problem with such an arrangement is that in locating the lever in a position that is convenient to the driver when adjusting the position of the steering wheel from being seated in the driver's seat, and making it rigid to give a quality feel, it is also in a position where it could be impacted by the drivers legs in an accident. This could lead to the lever injuring the driver.

### BRIEF SUMMARY OF THE INVENTION

A feature of the present invention is to ameliorate the problem of a driver being injured in the event of an impact with the lever during a collision of the vehicle.

According to a first aspect the invention provides a locking lever for a clamp mechanism of a steering column assembly comprising a first portion, a second portion that extends from the first portion, and a connecting portion or region between the first portion and the second portion about which the second portion may preferentially breakaway from the first portion in the event of an impact by an occupant of the vehicle on the second part, the lever further comprising a flexible tether that prevents the second portion fully separating from the first portion after the lever has broken about the connection portion or region.

The provision of the connecting portion or region that allows a second portion of the lever to breakaway from the rest of the lever reduces the risk of the driver being harmed by the lever. The tether in turn ensures that the broken away part of the lever does not fly off around the cabin of the vehicle which may potentially introduce a secondary risk of injury.

The connecting portion may comprise a weakened portion or region of the lever between the first and second portions about which the second portion of the lever will preferentially and repeatably break away from the first portion. The connecting portion should be relatively rigid prior to break away compared to the rigidity of the flexible tether after a breakaway.

The connecting portion or region may comprise a portion or region of known shear strength, being lower than the shear strength of the adjacent first and second portions of the lever. The shear strength should be chosen to ensure the lever does not break during normal adjustment but will break by an impact during a collision that exceeds the forces expected during normal adjustment.

The lever may comprise a, preferably plastic, component of unitary construction in which the first portion, second portion and connecting portion are all integral parts. The plastic component may comprise an outer shell and a plurality of internal webs that provide rigidity to the shell. It may be an injection molded component or may be produced in any other known manufacturing process.

The tether may comprise a flexible strap that is integrally connected at one end to the first portion and integrally connected at the other to the second portion. Where the lever is a plastic component of unitary construction the strap may also be an integral part of the component. The strap, first part and second part may all be molded as one unitary component.

To optimise the flexibility of the strap it may only be connected to the first part and second part at the ends of the strap with no connection therebetween in the manner of a carry handle of a case.

As an alternative to the integral strap secured at its ends only, the tether may comprise a portion of material that has a higher elasticity that than the material that forms the first portion or second portion or connecting portion or zone, the portion of material being embedded wholly or partially within the lever such that part of the tether is embedded in the first portion and another part of the tether is embedded in the second portion.

The embedded flexible portion of material should be constructed and arranged to permit the second part of the lever to mover relatively freely relative to the first part when the second part has broken away. It should therefore be much more flexible that the connecting part when the connecting part has broken.

For example, to manufacture a lever a twin shot molding tool may be used. A suitable flexible material for the tether may be Santoprene(Rubber).

In another arrangement, the tether may comprise a wire or cord, such as metal wire, that may be secured in one region to the first part and secured in another region spaced along the wire to the second part. The wire may be overmolded with the first and second portions of the lever where the lever is a molded component.

In yet another arrangement the tether may comprise a length of tape that is fixed to the first part at one end and to the second part at the other end. The tape may be wrapped around the lever. The tape may be provided with an adhesive backing along at least a part of its length so as to adhere the tape to the first portion and the second portion.

In another arrangement, the tether may comprise a resilient band that is hooked onto a first hook secured to, or integral to, the first part, and hooked onto a second hook secured to, or integral with, the second part, the loop being restrained such that it is cannot separate from the hooks. The band could comprise a rubber band, or other elastomeric material, and may include undersized holes that the hooks pass through.

Where the lever is a plastic component the hooks may be moulded into the first and second parts of the handle.

Where we refer to the tether being flexible, we may mean that it is able to bend relatively freely in one, or two, or all three possible orthogonal directions, and/or that it is able to rotate around one, or two or all three possible orthogonal axes.

The second portion may comprise a protruding handle portion of the lever, sized such that it can be grasped by an occupant of the vehicle to adjust the clamp mechanism. The first portion may comprise a root portion that is suitable for connecting to a clamp pin or bolt of a clamp mechanism, the handle being further from the axis of the clamp pin or bolt than the root portion. The clamp pin may pass through an opening in the first portion of the lever, the handle being rotatable about the axis of the clamp pin or bolt.

The first portion may comprise a plastic component that is overmolded onto a metal support, the metal support providing an anchor for fixing the lever to a clamp pin on a clamp mechanism of a steering column assembly.

According to a second aspect the invention provides a steering column assembly comprising a shroud that supports a steering column, a support bracket that in use is fixed in position within a vehicle, and a clamp mechanism that secures the shroud to the support bracket, the clamp mechanism including a lever according to the first aspect of the invention.

The first portion of the lever and the connecting portion may be located inside of the shroud or a cover part of the steering assembly so that on break away occupant is isolated from the first part of the lever by the shroud or cover. The second part may be located outside of the shroud or cover where it can be grabbed by an occupant.

Other advantages of this invention will become apparent to those skilled in the art from the following detailed description of the preferred embodiments, when read in light of the accompanying drawings.

### BRIEF DESCRIPTION OF THE DRAWINGS

FIG. 1 shows in cross section a representative steering column assembly that falls within the scope of the second aspect on the invention;

FIG. 2 is a representation of a first embodiment of a handle for the assembly of FIG. 1

FIG. 3 is a sequence showing the breaking of the handle from (a) an unbroken, to (b) a part broken and (c) a broken away condition, illustrating how the tether prevents full separation of the parts of the lever;

FIG. 4 is a representation of a second embodiment of a handle for the assembly of FIG. 1;

FIG. 5 is a representation of a third embodiment of a handle for the assembly of FIG. 1;

FIG. 6 is a representation of a fourth embodiment of a handle for the assembly of FIG. 1; and

FIG. 7 is a representation of a fifth embodiment of a handle for the assembly of FIG. 1.

### DETAILED DESCRIPTION OF THE INVENTION

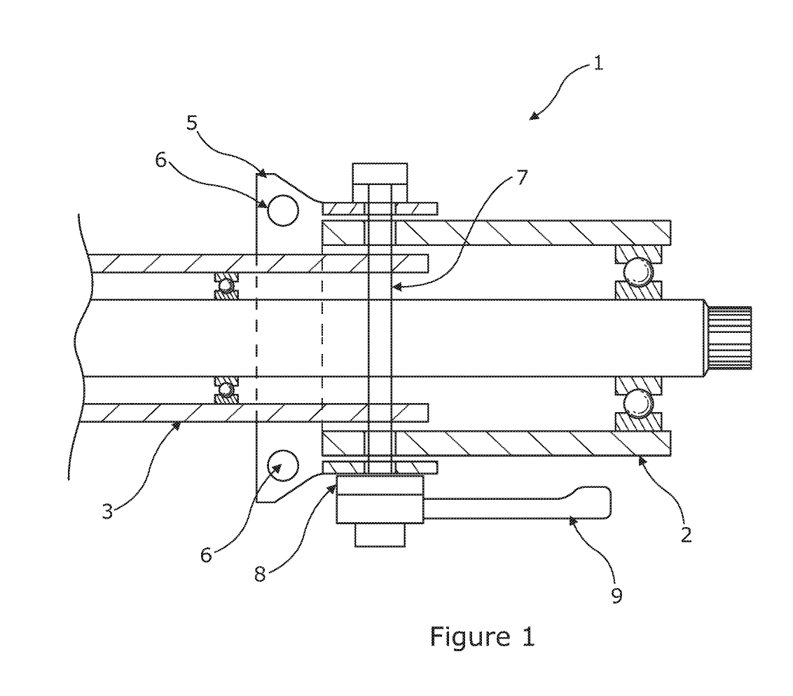

As shown in FIG. 1, a steering column assembly 1 comprises a two part telescopic shroud 2, 3 that supports a two part telescopic steering shaft 4, a support bracket 5 that in use is fixed in position within a vehicle by bolts not shown that pass through openings 6 in the support bracket, and a clamp mechanism that secures the shroud to the support bracket. The clamp mechanism includes a clamp pin 7 that extends through an opening in the shroud and in the support bracket, and a cam mechanism 8 that is threaded onto the clamp pin 7. The cam mechanism is operable to clamp and unclamp depending arms of the support bracket onto the shroud 2, 3 by rotation of the clamp pin 7 around its axis. A user operable lever 9 is fixed to the clamp pin 7 that can be grasped by an occupant and allows the occupant to operate the clamp mechanism by applying a torque to the clamp pin. The lever 9 is located to the side of the steering column assembly in easy reach of the driver when seated.

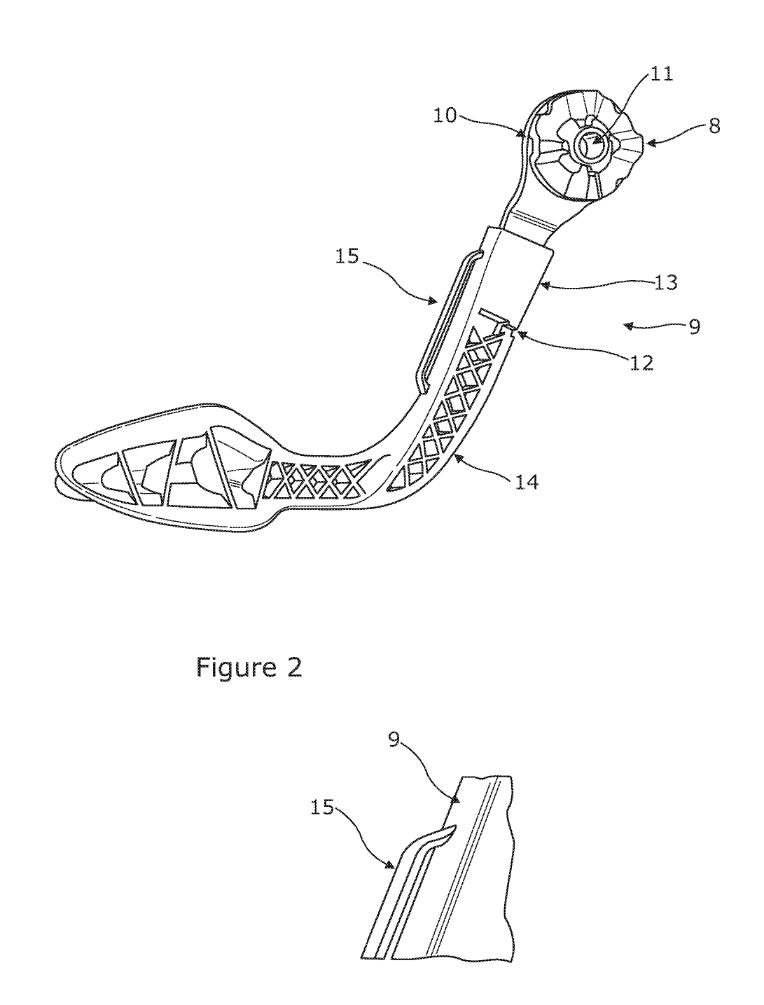

A first embodiment of a lever 9 is shown in FIG. 2. The lever 9 comprises an elongate body of plastic which is overmolded at one end onto a metal fixing 10 designed to be secured to the clamp pin. The fixing is a metal plate with a central opening 11 that threads onto the clamp pin 7. As shown a part of the cam mechanism 8 is fixed onto this plate. The plastic body has an outer shell and a set of webs that provide support and give rigidity to the shell. In this example the body is bent at about a right angle approximately half way along its length. A notch 12 is provided in the shell at the outside of the bend, between 3 and 4 mm deep. The notch defines a connecting region or zone between the terminal end of the lever that forms a handle and the end that is over moulded onto the metal connector. The lever in the language of this specification is therefore divided about the notch into a first part 13 (the end that is overmolded) and a second part 14 (the end that forms the handle).

The notch 12 defines a region of the lever 9 where it will fail when under an impact load, such as a driver's knee striking the handle part of the lever during a collision. The location of the notch 12 is chosen so that the location of the breakaway is outside of the knee zone of the driver.

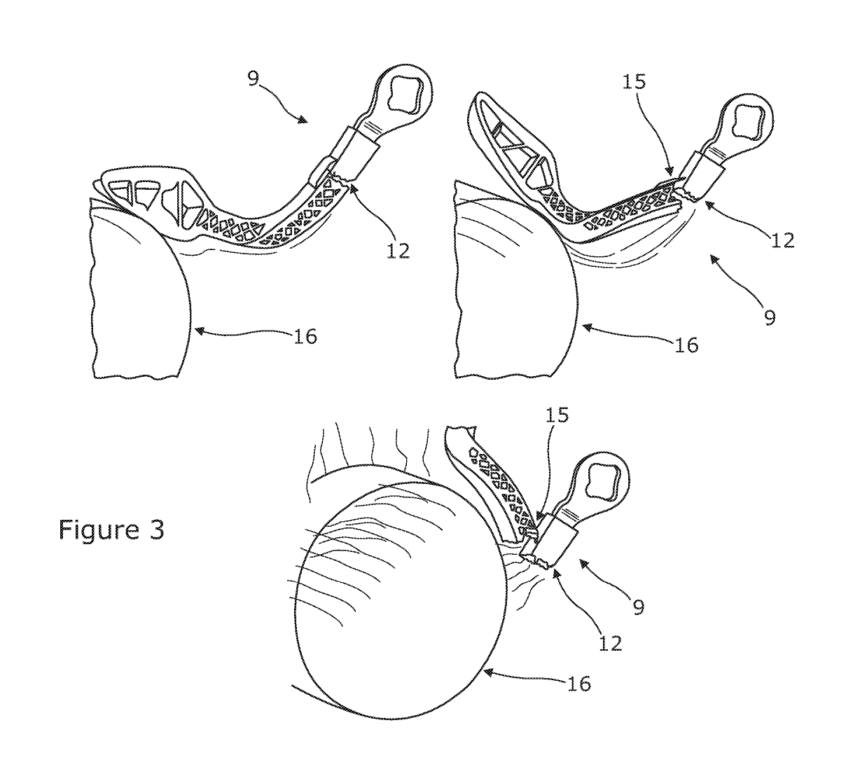

Connecting the first part 13 to the second part 14 is a tether in the form of a strap 15, which is an integrally formed part of the plastic lever. This can be seen clearly in FIG. 3 of the drawings. This is an elongate thin portion of plastic that is connected to the lever only at its extreme ends. The strap is considerably more flexible than the remainder of the lever. The strap and lever together form a closed loop of arbitrary shape.

In use, as shown in the sequence of FIG. 3, the strap 15 ensures that the handle part of the lever does not fully separate from the first part once a breakaway has occurred due to strike by an occupants knee 16 or similar, and yet it allows relatively free movement of the handle part so it has less risk of injuring the driver.

The strap could be provided on the opposite side of the lever to the notch, as shown, or in any other position. Indeed, the location at which the strap is tethered to the first portion and to the second portion of the lever, and the length and shape of the strap, may be chosen quite arbitrarily provided that the strap, once the lever has broken, performs the task of restraining the broken off portion.

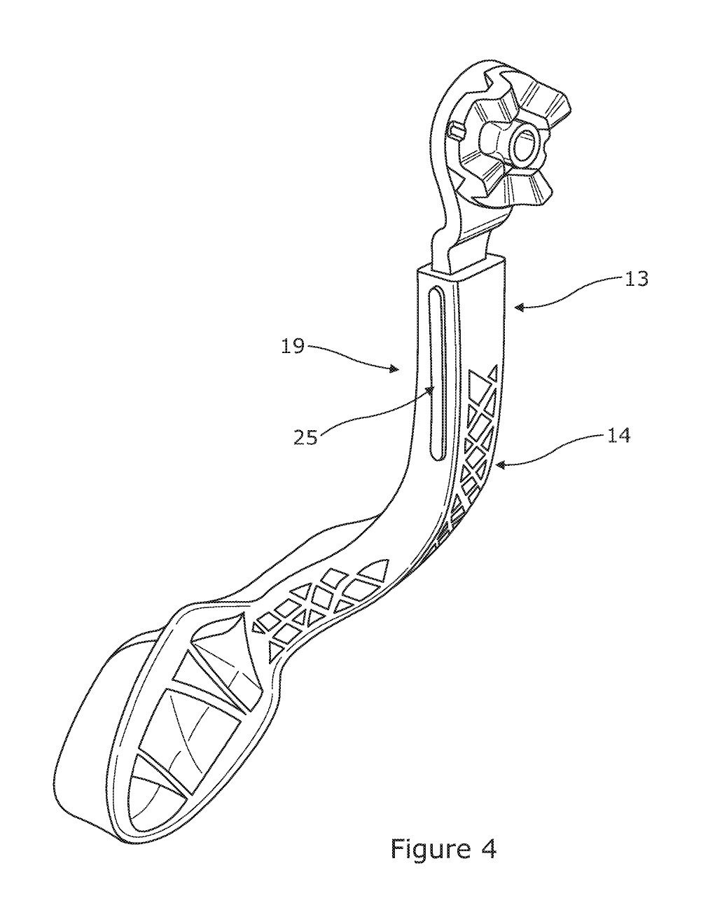

An alternative embodiment of a lever 19 is shown in FIG. 4. In this embodiment, the parts which are common with the first embodiment are identified using like reference numerals, which is also the case for the following embodiments for clarity. A tether 25 comprises a secondary material that is more flexible than the plastic (or other material) of the first part 13 and second part of the lever 14, which is embedded into the lever. This can be achieved using a two shot moulding process. The second material may be rubber. Once the lever 19 has broken away, about the notch 12, the tether prevents the full separation of the handle part of the lever from the end connected to the clamp mechanism.

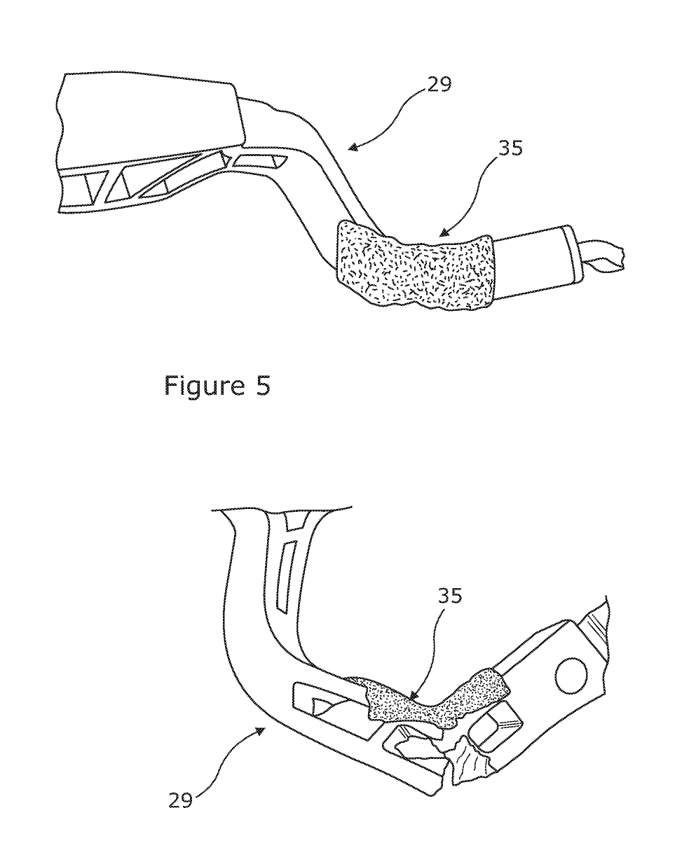

In another alternative embodiment of a lever 29 shown in FIG. 5, the tether 35 comprises a length of tape that is wound around the lever to grip the first part and the second part. The tape 35 may comprise a fabric or plastic sheet material with an adhesive backing that ensures it does not separate from the lever 29. In a modification, the lever could be shrink wrapped using a thermo-shrinking tube of material that in a pre-shrunk state can be slid onto the lever and when heated will shrink onto and grip the first portion and second portion covering the area of expected breakage.

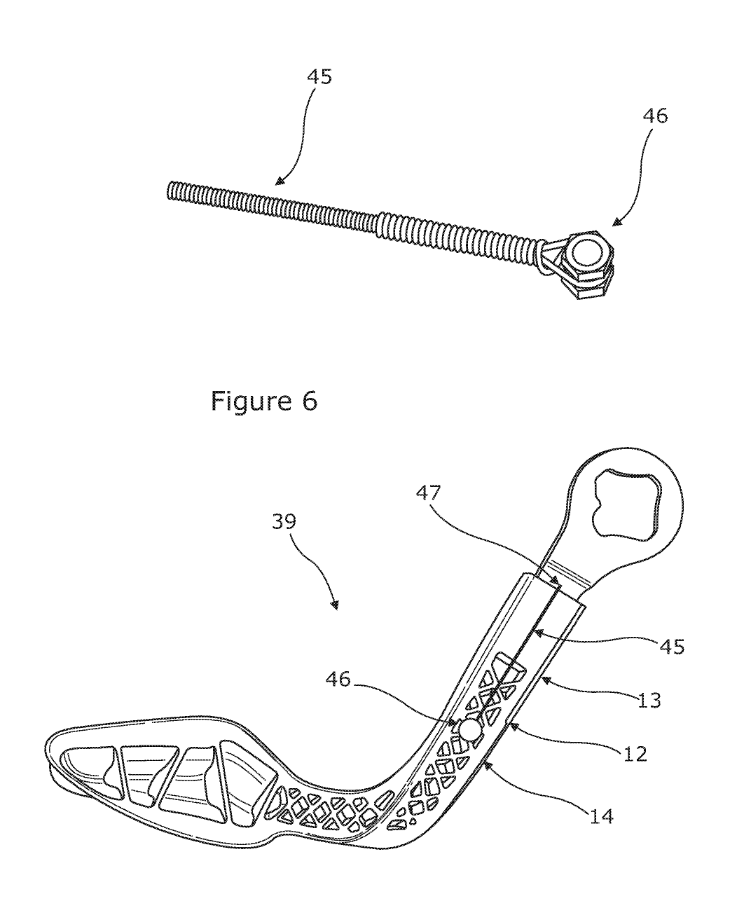

In a still further embodiment of a lever 39 shown in FIG. 6, the tether 45 comprises a flexible strand or rod, such as a metal wire that is embedded into the lever. As shown, one end of the wire 45 is welded by a spot weld 47 to the metal plate 10 and the other end is secured to a nut 46 that is captive in a recess in the handle part 14 of the lever. The wire may be a braided metal wire.

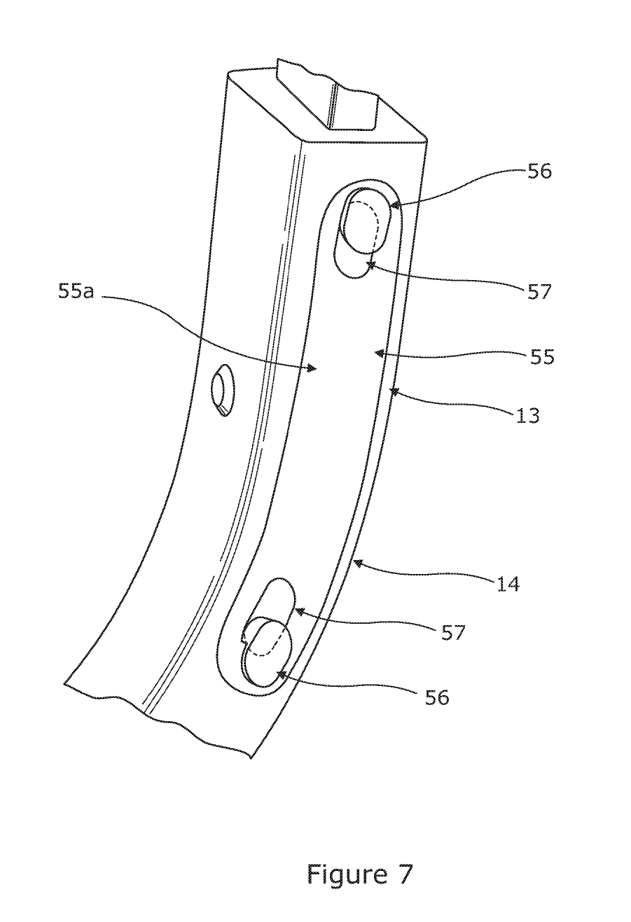

Finally in another embodiment of a lever 49 shown in FIG. 7, the tether 55 comprises a flexible strip 55a, for example of rubber material, that has two spaced apart openings 57, each one being pushed onto a hook 56 formed on the first part and second part respectively of the lever. The openings 57 are undersized so that the flexible strip grips onto the hooks. The hooks 56 are molded integrally with the first and second parts of the lever which are plastic material.

In accordance with the provisions of the patent statutes, the principle and mode of operation of this invention have been explained and illustrated in its preferred embodiments. However, it must be understood that this invention may be practiced otherwise than as specifically explained and illustrated without departing from its spirit or scope.

1. A locking lever for a clamp mechanism of a steering column assembly comprising a first portion, a second portion that extends from the first portion, and a connecting portion located between the first portion and the second portion about which the second portion will preferentially breakaway from the first portion in the event of an impact by an occupant of a vehicle on the second portion, the lever further comprising a flexible tether that prevents the second portion fully separating from the first portion after the lever has broken about the connecting portion.

2. The locking lever according to claim 1 in which the connecting portion comprises a weakened portion or region of the lever between the first and second portions about which the second portion of the lever will preferentially and repeatably break away from the first portion.

3. The locking lever according to claim 1 which comprises a component of unitary construction in which the first portion, second portion and connecting portions are all integral parts.

4. The locking lever according to claim 1 in which the tether comprises a flexible strap that is integrally connected at one end to the first portion and integrally connected at the other to the second portion.

5. The locking lever according to claim 4 in which the strap is only connected to the first portion and second portion at the respective ends of the strap with no connection therebetween.

6. The locking lever according to claim 1 in which the tether comprises a portion of material that has a higher elasticity that than the material that forms the first portion and the second portion and the connecting portion, the portion of material being embedded wholly or partially within the lever such that part of the tether is embedded in the first portion and another part of the tether is embedded in the second portion.

7. The locking lever according to claim 1 in which the tether comprises a wire or cord that is secured in one region to the first portion and secured in another region spaced along the wire to the second portion.

8. The locking lever according to claim 1 in which the tether comprises a length of tape that is fixed to the first portion at one end and to the second portion at the other end.

9. The locking lever according to claim 8 in which the tape is wrapped around the lever.

10. The locking lever according to claim 1 in which the tether comprises a resilient band that is hooked onto a first hook secured to, or integral to, the first portion, and hooked onto a second hook secured to, or integral with, the second portion, the band being restrained such that it is cannot separate from the hooks.

11. The locking lever according to claim 1 in which the second portion comprises a protruding handle portion of the lever, sized such that the handle portion can be grasped by an occupant of the vehicle to adjust the clamp mechanism.

12. The locking lever according to claim 1 in which the first portion comprises a root portion that is configured for connecting to a clamp pin or bolt of a clamp mechanism.

13. A steering column assembly comprising a shroud that supports a steering column, a support bracket that in use is fixed in position within a vehicle, and a clamp mechanism that secures the shroud to the support bracket, the clamp mechanism including the lever according to claim 1.

14. The locking lever according to claim 7 in which the tether comprises a metal wire or cord.
